(19) United States
(12) Patent Application Publication
(10) Pub. No.: US 2007/0253586 A1
(43) Pub. Date: Nov. 1, 2007

(54) Behind-the-ear hearing device including eyeglass adapter with thin sound tube

(75) Inventors: Wemer Fickweiler, Bubenreuth (DE); Esfandiar Grafenberg, Effeltrich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/787,689

(22) Filed: Apr. 17, 2007

(30) Foreign Application Priority Data
Apr. 19, 2006 (DE) 10 2006 018 154.9

(51) Int. Cl. H04R 25/00

(52) U.S. Cl. 381/330; 381/327

(57) ABSTRACT

A behind-the-ear hearing device is provided for an eyeglass wearer that is equipped with a thin hearing tube (maximum 2 mm) and is nevertheless comfortable. A hearing device suitable for this purpose has a hearing device housing having a sound outlet and an eyeglass temple adapter, fastened to the hearing device housing and attachable to an eyeglass temple. The thin hearing tube leads through the eyeglass temple adapter to the sound outlet of the hearing device housing for sound transmission in an auditory canal. This enables a voluminous ear hook to be dispensed with and a thinner hearing tube used and allows the sound to be transported directly from the hearing device housing to the sound tube.

### CROSS REFERENCE TO RELATED APPLICATIONS

This application claims priority of German application No. 10 2006 018 154.9 filed Apr. 19, 2006, which is incorporated by reference herein in its entirety.

### FIELD OF THE INVENTION

The present invention relates to a behind-the-ear hearing device for eyeglass wearers comprising a hearing device housing having a sound outlet and an eyeglass temple adapter which is fastened to the hearing aid housing and can be attached to an eyeglass temple. The term “hearing device” can generally be understood here to mean a hearing apparatus which can be connected to a pair of eyeglasses by means of an eyeglass adapter and is worn behind the ear. Hearing apparatus of this type would include for example a headset or headphones.

### BACKGROUND OF THE INVENTION

Usually the sound tube of a behind-the-ear hearing device has an external diameter of at least 3 mm via which the sound is transmitted from the hearing device to the auditory canal. A tube 1 of this type is shown schematically in FIG. 1 fixed to a hearing device 2. In order to connect the tube 1 to the hearing device housing 3 of the hearing device 2, an eyeglass adapter 4 is used. It is clipped or screwed onto the hearing device housing 3. At the same time, the eyeglass adapter 4 has the function of an ear hook as is known from conventional behind-the-ear hearing devices and therefore has an ear hook section 5. A sound canal 6 runs through the inside of the ear hook section 5 which transports the sound from a sound outlet connecting piece of the hearing device housing 3 to the sound tube 1. The sound tube 1 is clipped or glued to the end of the ear hook section 5. This is easily feasible because it has a sufficiently large internal and external diameter.

An eyeglass temple holding section 7 is formed on the ear hook section 5 of the eyeglass adapter 4. The end of an eyeglass temple can be clipped or glued into said eyeglass temple holding section 7.

For cosmetic reasons, hearing device wearers, however, prefer thinner tubes that are less optically conspicuous when they are worn in the top, front region of the ear muscle. In this case thin tubes are considered to be tubes with a maximum external diameter of 2 mm. Eyeglass wearers, who want to use a behind-the-ear hearing device with such a thin tube have had to accept for a long time that the eyeglass temple and the hearing device with the tube must have to be accommodated behind the ear muscle. This gives the impression that the hearing device is larger and pressure points develop on the skin.

A hearing apparatus for eyeglass wearers is known from publication WO 97/11574 A1. With the aid of an adapter the eyeglass temple can be attached to the sound tube of the hearing apparatus which is routed through the auditory canal. Alternatively the adapter can be used to attach the eyeglass temple to the hearing apparatus module itself.

Furthermore, the publication document EP 1 727 393 A1 discloses a connector assembly for connecting an earpiece of a hearing device to the eyeglass temple. The eyeglass temple itself serves as a housing for the hearing device electronics. A sound tube which is fastened to the eyeglass temple transports the sound to an earpiece worn in the ear.

Furthermore U.S. Pat. No. 3,825,700 discloses a hearing device housing comprising two parts which serves as an eyeglass temple at the same time. The two housing sections are connected by means of a coupling element, through which the sound is transported.

Finally U.S. Pat. No. 3,102,172 also discloses an eyeglass temple which serves as a hearing device housing. A sound tube leads through from the hearing device housing toward an earpiece.

### SUMMARY OF THE INVENTION

The object of the present invention is to provide a behind-the-ear hearing device with a thin sound tube which can be worn more comfortably together with a pair of eyeglasses.

According to the invention, this object is achieved by means of a behind-the-ear hearing device for eyeglass wearers with a hearing device housing having a sound outlet and an eyeglass temple adapter directly attached to the hearing device housing and to an eyeglass temple formed in two parts with the hearing device housing, a hearing tube being routed for transmission of sound in an auditory canal by means of the eyeglass temple adapter to the sound outlet of the hearing device housing.

Advantageously, thin hearing tubes can be used in a behind-the-ear hearing device of this type. These are accepted more readily from the cosmetic point of view. Furthermore the hearing device is held on the ear muscle with the aid of the eyeglass temple adapter and a conspicuous ear hook can be dispensed with.

Preferably the hearing tube has a maximum external diameter of 2 mm. This means that it is particularly readily accepted by hearing device wearers.

The hearing tube, also referred to as a sound tube, is advantageously screwed, clipped or glued to the sound outlet of the hearing device housing. A soundproof connection to the hearing device housing or to the receiver in the hearing device housing can therefore be established.

According to a further embodiment, the hearing tube can be injection molded to the eyeglass adapter. This can be carried out by means of a two-component injection mold procedure and the effort and expenditure involved in the logistics and assembly for the hearing device or hearing apparatus is thereby reduced.

According to a further development, the eyeglass adapter or a part thereof can be connected in one piece to the hearing device housing or part thereof. Even in this procedure the opportunity exists to reduce the individual components of a hearing device or hearing apparatus or part thereof. The hearing tube can then be assembled, by way of example, between two half-shells which form the hearing device housing together with the eyeglass adapter.

The eyeglass adapter can, however, also be screwable or clippable to the hearing device housing. Hence one and the same eyeglass adapter can be used for different hearing device housings.

### BRIEF DESCRIPTION OF THE DRAWINGS

The present invention will now be described in more detail with reference to the accompanying drawings in which:

FIG. 1 shows a behind-the-ear hearing device with an eyeglass adapter according to the prior art and

FIG. 2 shows a behind-the-ear hearing device with eyeglass adapter and thin sound tube according to the invention.

### DETAILED DESCRIPTION OF THE INVENTION

The following exemplary embodiment described in more detail in the following presents a preferred embodiment of the present invention.

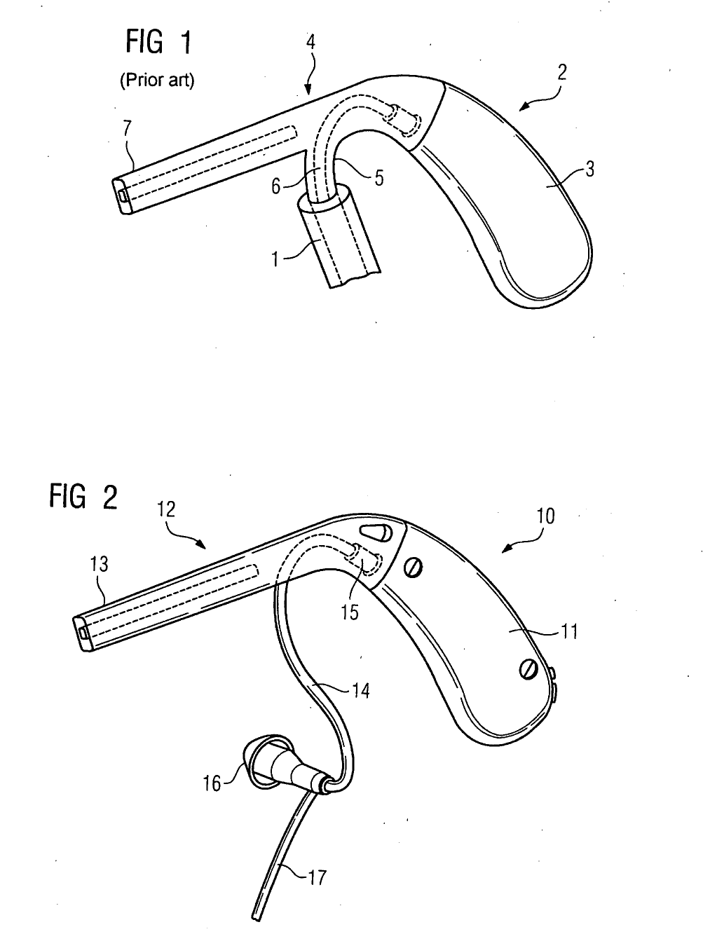

In the hearing device 10 depicted in FIG. 2 the hearing device housing 11 is connected to an eyeglass adapter 12. Typically the two elements are connected by clipping or screwing. The eyeglass adapter 12 is of a rectangular design and can be attached to the end 13 of an eyeglass temple (not shown) lying opposite the hearing device housing 11. For this purpose it has a blind hole recess like the eyeglass adapter from the prior art shown in FIG. 1.

Here, the eyeglass adapter 12 does not have an ear hook onto which a thicker hearing tube can be slipped. Rather a thinner heavier tube 14 is routed in a corresponding channel within the eyeglass adapter 12 at the connection end of the eyeglass adapter 12 to the hearing device housing 11. The hearing tube 14 is connected there to a collar 15. However it can also be fixed, e.g. glued, screwed, clipped onto or injection molded elsewhere in the eyeglass adapter. By means of the collar 15, the hearing tube 14 is connected in a soundproof manner to the sound outlet connecting piece of the hearing device 10 or the hearing device housing 11.

The thin hearing tube 14 runs through the adapter channel 12 from the collar 15 initially approximately in the longitudinal direction of the eyeglass adapter 12. It then leaves the eyeglass adapter 12 in a curved manner so that practically an ear hook arises with the hearing tube 14 and the eyeglass adapter 12 with the aid of which a stable fit of the hearing device behind the ear muscle is possible.

In the example of FIG. 2, an ear adapter is positioned at the free end of the hearing tube 14. A flexible, longitudinal fixing element 17 is molded thereto. This fixing element 17 is fixed to the arches of an ear muscle and serves for more effectively holding the ear adapter 16 in the auditory passage.

By avoiding a relatively voluminous ear hook and a thick hearing tube attached thereto, the hearing device including the tube is less conspicuous. With the inventive eyeglass adapter, pressure points on the ear of the hearing device wearer can also be avoided even when he or she is wearing eyeglasses and nevertheless wishes to use a hearing device with a thin hearing tube.

Furthermore the hearing tube 14 routed through the eyeglass adapter 12 according to the invention guarantees the direct connection of the hearing tube 14 to the sound outlet connecting piece of the hearing device housing 11 without a sound transporting channel in the eyeglass temple adapter having to be connected therebetween and thus reducing the acoustic losses.

1.-6. (canceled)

7. A behind-the-ear hearing device, comprising:
a hearing device housing having a sound outlet;
an eyeglass temple adapter directly fastened to the hearing device housing; and
a hearing tube that is routed to the sound outlet of the hearing device housing via the eyeglass temple adapter for transmitting sound in an auditory canal of a wearer of the behind-the-ear hearing device.

8. The behind-the-ear hearing device as claimed in claim 7, wherein a maximum external diameter of the hearing tube is 2 mm.

9. The behind-the-ear hearing device as claimed in claim 7, wherein the hearing tube is screwed, clipped, or glued to the sound outlet of the hearing device housing.

10. The behind-the-ear hearing device as claimed in claim 7, wherein the hearing tube is injectively molded into the eyeglass temple adapter.

11. The behind-the-ear hearing device as claimed in claim 7, wherein the eyeglass temple adapter or part of the eyeglass adapter and the hearing device housing or part of the hearing device housing is connected as one single piece.

12. The behind-the-ear hearing device as claimed in claim 7, wherein the eyeglass temple adapter is screwable or clippable to the hearing device housing.

13. The behind-the-ear hearing device as claimed in claim 7, wherein the eyeglass temple adapter is attachable to an eyeglass temple.

14. The behind-the-ear hearing device as claimed in claim 7, wherein the eyeglass temple adapter does not have an ear hook.

15. A method for an eyeglass wearer to wear a behind-the-ear hearing device, comprising:
arranging a sound outlet in a housing of the behind-the-ear hearing device;
fastening an eyeglass temple adapter to the hearing device housing;
routing a hearing tube to the sound outlet of the hearing device housing via the eyeglass temple adapter; and
transmitting sound in an auditory canal of the wearer by the hearing tube.

16. The method as claimed in claim 15, wherein a maximum external diameter of the hearing tube is 2 mm.

17. The method as claimed in claim 15, wherein the hearing tube is screwed, clipped, or glued to the sound outlet of the hearing device housing.

18. The method as claimed in claim 15, wherein the hearing tube is injectively molded into the eyeglass temple adapter.

19. The method as claimed in claim 15, wherein the eyeglass temple adapter or part of the eyeglass adapter and the hearing device housing or part of the hearing device housing is connected as one single piece.

20. The method as claimed in claim 15, wherein the eyeglass temple adapter is screwable or clippable to the hearing device housing.

21. The method as claimed in claim 15, wherein the eyeglass temple adapter is attachable to an eyeglass temple.

22. The method as claimed in claim 15, wherein the eyeglass temple adapter does not have an ear hook.
